(19) United States
(12) Patent Application Publication
(10) Pub. No.: US 2014/0203072 A1
(43) Pub. Date: Jul. 24, 2014

(54) METHOD AND SYSTEM FOR TRACKING MODIFICATIONS IN A DOCUMENT

(71) Applicant: XEROX CORPORATION, Norwalk, CT (US)

(72) Inventors: Thomas Jackson, Corning, NY (US); Todd W. Schuler, Rochester, NY (US); Ross Keptner, Rochester, NY (US)

(73) Assignee: XEROX CORPORATION, Norwalk, CT (US)

(21) Appl. No.: 13/746,344

(22) Filed: Jan. 22, 2013

(51) Int. Cl. G06F 17/24; G06F 17/30

(52) U.S. Cl. CPC G06F 17/24; G06F 17/30011
USPC 235/375; 715/256

(57) ABSTRACT

A method, system, and computer program product for tracking modifications in a document. One or more fields in the document are defined. The modifications in the document are then tracked. Thereafter, a machine-readable code (MRC) is generated based on the recorded modifications. The MRC is then embedded in the document. The MRC may be scanned any time to view the information on the modifications.

### TECHNICAL FIELD

The presently disclosed embodiments are related to tracking modifications in a document. More particularly, the presently disclosed embodiments are related to a technique for generating a machine-readable code for tracking the modifications in the document.

### BACKGROUND

The word processing software has revolutionized the manner in which people create or modify various documents on computers and, in some cases, has created whole industries, such as the desktop publishing industry. During the process of the creating and modifying the documents, maintaining the change history of the documents may be an important task for certain applications. For instance, when documents are created by more than one author, or are very large and complex, they are often revised many times before a final document is created. During the course of revisions, it is frequently desired to maintain a complete copy or version of the document before the new changes are introduced. This version may then be used as a comparison document with the current document to quickly locate the changes or may be used to reverse or “undo” the changes. Depending on the document's complexity or the number of people involved in its creation, multiple copies or versions of the document needs to be stored. Further, in case of printed documents, it becomes very difficult to track changes by manual comparison.

### SUMMARY

According to the embodiments illustrated herein, a method for tracking modifications in a document has been provided. The method includes defining one or more fields in the document. The method includes recording the modifications in the document. The method includes generating a machine-readable code (MRC) based on the modifications, and embedding the machine-readable code (MRC) in the document.

According to the embodiments illustrated herein, a system for tracking modifications in a document has been provided. The system includes a user interface module, a recording module, a code generator module, and a printer module. The user interface module is configured for receiving one or more inputs for defining one or more fields. The recording module configured is for recording the modifications in the one or more fields of the document. The code generator module is configured for generating a machine-readable code (MRC) based on the modifications in the one or more fields. The code generator module is further configured for determining a position of the MRC in the document, and thereafter embedding the MRC in the document. The printer module is configured for facilitating printing of the document with the embedded MRC, wherein the printed document is scanable to output the information on the modifications.

According to the embodiments illustrated herein, a computer program product for use with a computer for tracking modifications in a document has been provided. The computer readable program code includes program instruction means for defining one or more fields in the document. The computer readable program code includes program instruction means for recording the modifications in the document. The computer readable program code includes program instruction means generating a machine-readable code (MRC) based on the modifications, and embedding the machine-readable code (MRC) in the document.

According to the embodiments illustrated herein, a method for tracking modifications in a document has been provided. The method includes defining one or more fields in the document. The method includes recording the modifications in the document. The method includes generating a machine-readable code (MRC) based on the modifications, and embedding the machine-readable code (MRC) in the document. The method includes printing the document with the embedded MRC and thereafter scanning the MRC in printed document to output information on the modifications.

### BRIEF DESCRIPTION OF DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system environment in accordance with at least one embodiment;

FIG. 2a depicts a layout of an document in accordance with at least one embodiment;

FIG. 2b depicts a layout of the document with one or more fields highlighted in accordance with at least one embodiment;

FIG. 2c depicts a layout of the document containing machine-readable code (MRC) in accordance with at least one embodiment;

FIG. 3 is a block diagram illustrating a computing device in accordance with at least one embodiment; and

FIG. 4 is a flow diagram illustrating a method for tracking modifications in a document in accordance with at least one embodiment.

### DETAILED DESCRIPTION

The present disclosure is best understood with reference to the detailed figures and description set forth herein. Various embodiments have been discussed below with reference to the figures. However, those skilled in the art will readily appreciate that the detailed descriptions given herein with respect to the figures are simply for explanatory purposes, as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### DEFINITIONS

The following terms shall have, for the purposes of this application, the respective meaning set forth below.

A “machine-readable code” (MRC) refers to a code that is readable by an electronic machine equipped with appropriate scanning apparatus and/or image processing algorithms. Examples of the MRC include, but are not limited to, a one-dimensional barcode, such as a Universal Product Code (UPC); a two-dimensional bar code, such as a Quick Response (QR) code and a High Capacity Color Barcode; and a MaxiCode.

A “multifunction device” (MFD) refers to a device that can perform multiple functions. Examples of the functions include, but are not limited to, printing, scanning, copying, faxing, emailing, and the like.

A “computing device” refers to a computer, a device including a processor/microcontroller and/or any other electronic component, device or system that performs one or more operations according to one or more programming instructions. Examples of the computational device include, but are not limited to, a desktop computer, a laptop, a personal digital assistant (PDA), a Smartphone, an MFD, and the like. The computational device is capable of accessing (or being accessed over) a network (e.g., using wired or wireless communication capabilities).

A “network” refers to a medium that interconnects a server and various computational devices. Examples of the network include, but are not limited to, LAN, WLAN, MAN, WAN, and the Internet. Communication over the network may be performed in accordance with various communication protocols such as Transmission Control Protocol and Internet Protocol (TCP/IP), User Datagram Protocol (UDP), and IEEE 802.11n communication protocols.

A “scanner” refers to any apparatus, such as a digital imager, a copier, and a multi-function machine, which performs a scan output function for any purpose.

A “document” contains data, which may include text, numbers, and graphics. The document may further refer to information (such as text, numbers, and graphics) recorded in a manner that requires a computing device or other electronic device to display, interpret, and process it. In an embodiment, the document is a physical document, such as, paper document. In another embodiment, the document is an electronic document.

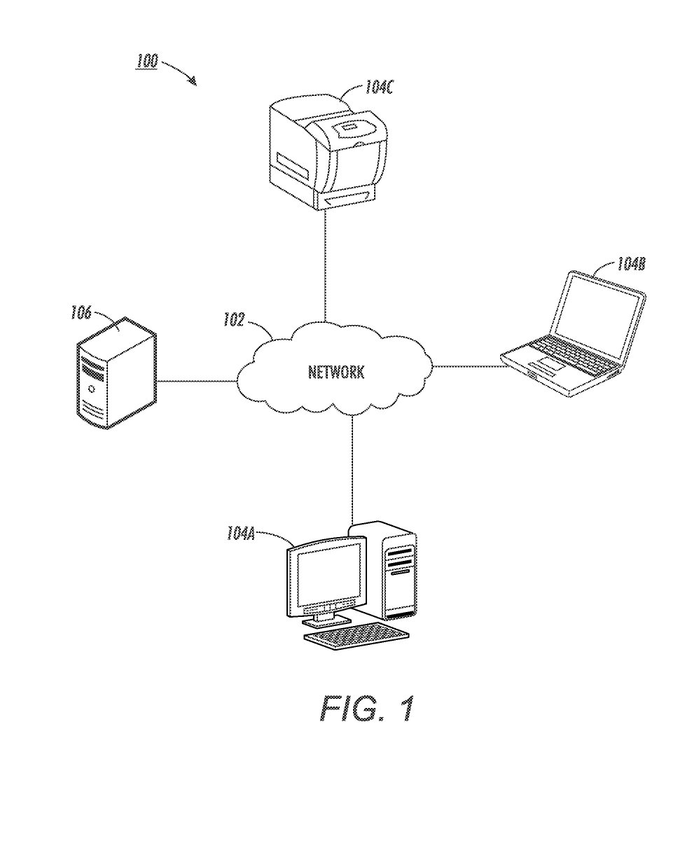

FIG. 1 is a block diagram illustrating a system environment 100 in accordance with at least one embodiment. Various embodiments of the methods and systems for tracking modifications in a document can be implemented in the system environment 100. The system environment 100 includes a network 102. The system environment 100 further includes a desktop computer 104a, a laptop 104b, an MFD 104c (hereinafter referred to as computing device 104), and a server 106.

A user operating the desktop computer 104a or the laptop 104b is capable of accessing the MFD 104c and/or the server 106 through the network 102. A functionality of tracking the modifications in the document and subsequently generating the MRC for the document can be implemented on at least one of the desktop computer 104a, the laptop 104b, the MFD 104c, and the server 106. In an embodiment, for example, the desktop computer 104a and/or the laptop 104b are capable of executing an application for generating the MRC for the document. In another embodiment, the server 106 hosts the application and the desktop computer 104a and/or the laptop 104b are capable of accessing the application over the network 102.

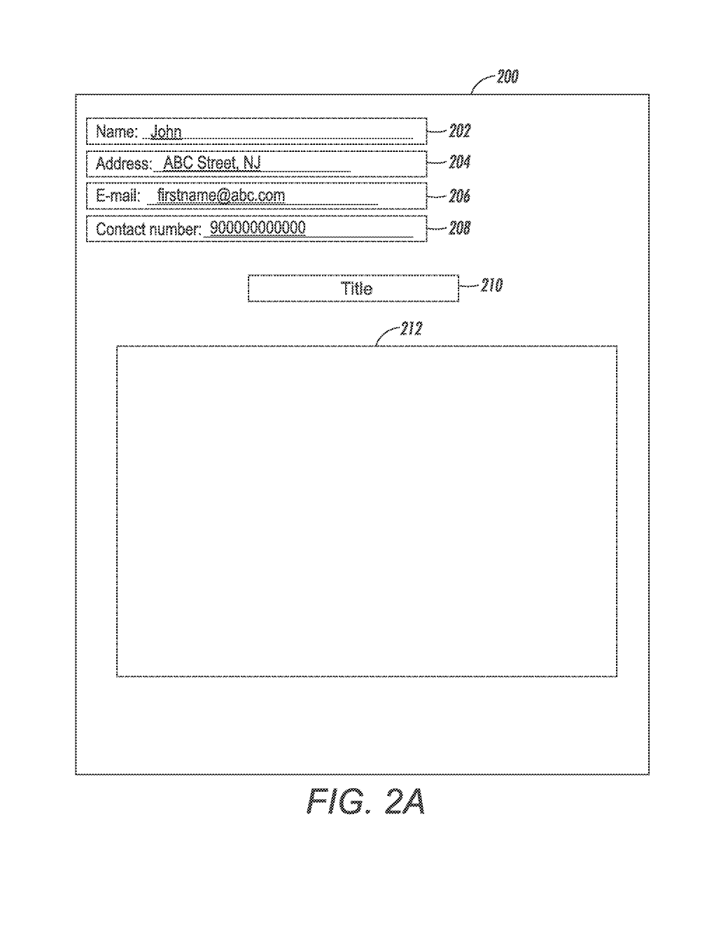

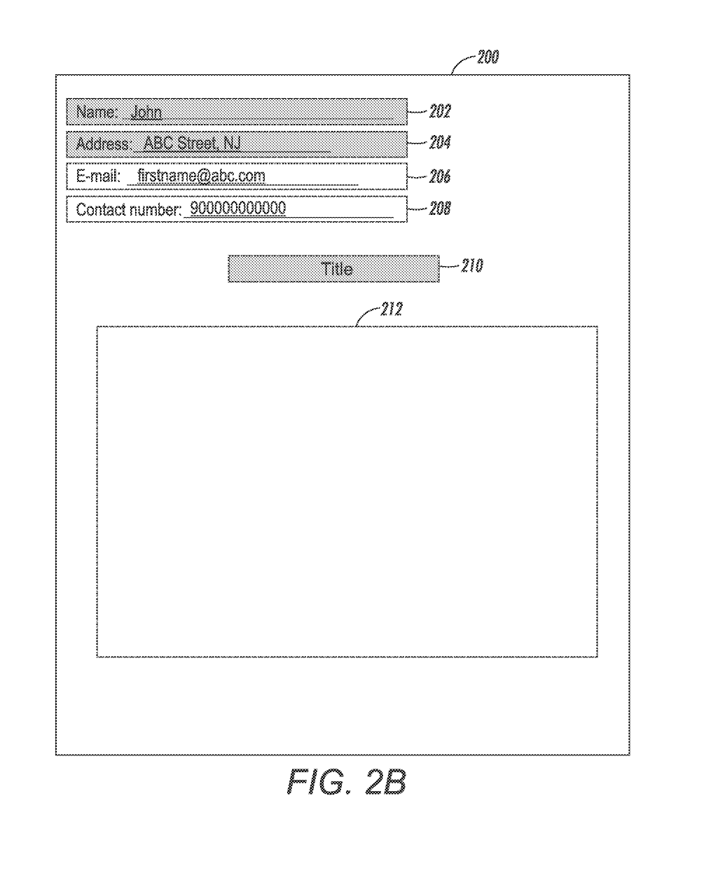

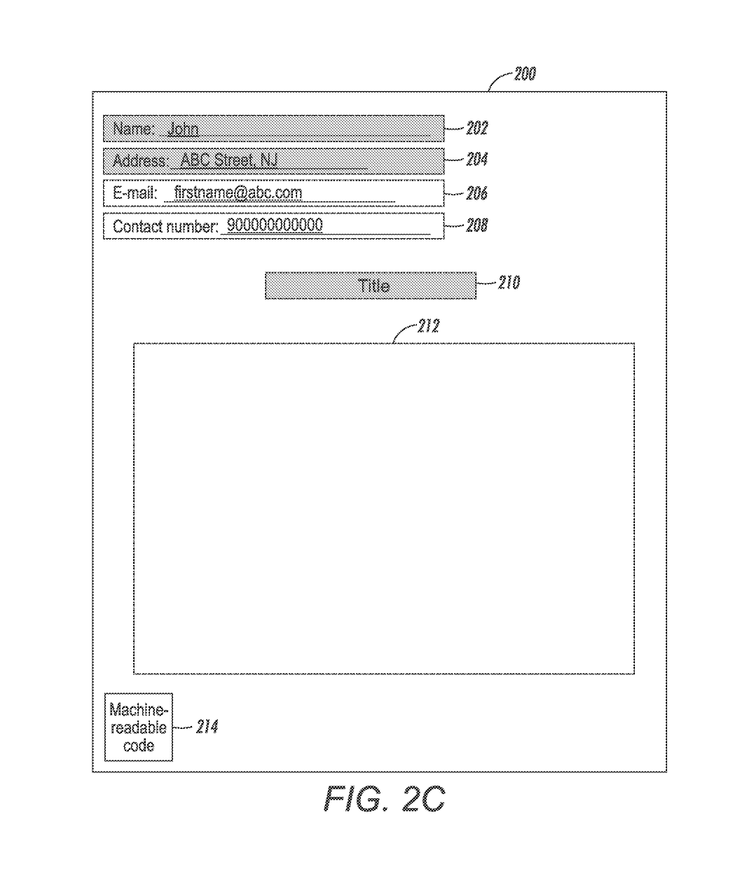

FIG. 2a depicts the layout of a document 200 in accordance with at least one embodiment. The layout of the document 200 includes a context field and a content field. The user-related information fields, such as name 202, address 204, email 206, and contact number 208 are grouped into the context field. The layout further includes subject matter related fields, such as a title 210 and a description 212. The title 210 is categorized into the context field while the description 212 is categorized as the content field. The description 212 contains various details including, but not limited to, various text, symbols, pictures, and so forth. The various fields such as the context field and the content field may vary in different documents without departing from the scope of the ongoing description. In addition, there can be more fields other than those described above in the document 200.

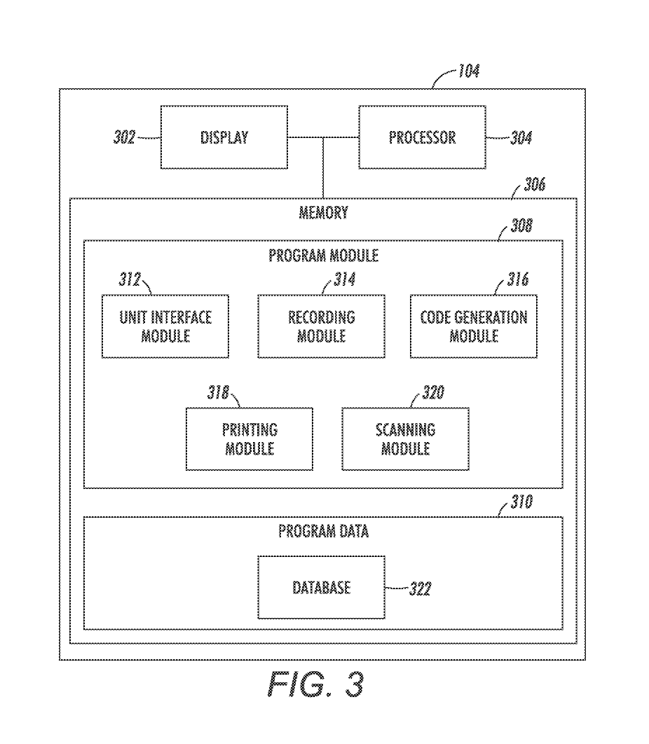

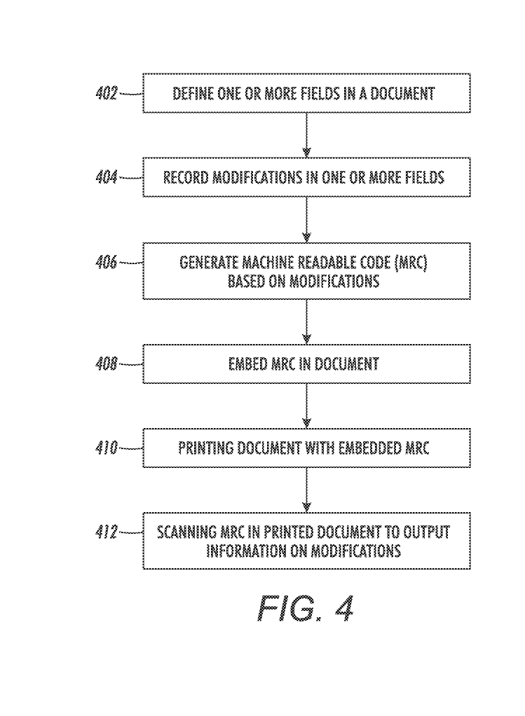

FIG. 2b depicts a layout of the electronic document with the one or more fields highlighted in accordance with at least one embodiment. In an embodiment, the user selects one or more fields in the document. The one or more fields include a content field and a context field. The context fields such as the user-related information fields and the title field available in the document 200 are highlighted (in grey color). This is further explained in detail in conjunction with FIG. 3 and FIG. 4.

FIG. 2c depicts a layout of the document containing an MRC 214 in accordance with at least one embodiment. The MRC 214 is generated based on the modifications performed in the document 200 and is embedded at a suitable position in the document 200. The modification includes the change of the address 204 from “NJ” as depicted in FIG. 2b to “NYC” as shown in FIG. 2c. This is further explained in detail in conjunction with FIG. 3 and FIG. 4.

FIG. 3 is a block diagram illustrating a computing device 104 (such as, the desktop computer 104a, the laptop 104b, or the MFD 104c) in accordance with at least one embodiment.

The computing device 104 includes a display 302, a processor 304, and a memory 306. The memory 306 includes a program module 308 and a program data 310. The program module 308 includes a user interface module 312, a recording module 314, a code generation module 316, and a printing module 318. The program data 310 includes a database 322. In an embodiment, the memory 306 functions under the control of the processor 304.

The display 302 facilitates the user to view information and interact with the computing device 104 in conjunction with various input mediums (not shown). The display 302 can be realized through several known technologies, such as Cathode Ray Tube (CRT)-based display, Liquid Crystal Display (LCD)-based display, Light Emitting Diode (LED)-based display, Organic LED-based display, and Retina-based display technology. Further, the display 302 can be a touch screen that receives a user input.

The processor 304 is coupled to the display 302, one or more input mediums, and the memory 306. The processor 304 executes a set of instructions stored in the memory 306 to perform one or more operations on the computing device 104. The processor 304 can be realized through a number of processor technologies known in the art. Examples of the processor 304 include, but are not limited to, X86 processor, RISC processor, ASIC processor, CISC processor, or any other processor. In an embodiment, the processor 304 includes a Graphics Processing Unit (GPU) that executes the set of instruction to perform one or more image processing operations.

The memory 306 stores set of instructions and data. Some of the commonly known memory implementations are, but not limited to, a random access memory (RAM), a read only memory (ROM), a hard disk drive (HDD), and a secure digital (SD) card. The program module 308 includes a set of instructions that are executable by the processor 304 to perform specific actions on the computing device 104. It is understood by a person having ordinary skills in the art that the set of instructions works in conjunction with various hardware of the computing device 104 to perform various operations. The database 322 stores data submitted from and/or required by the user interface module 312, the recording module 314, the code generation module 316, and the printing module 318. In an embodiment, the database 322 can be implemented using technologies including, but not limited to Oracle®, IBM DB2®, Microsoft SQL Server®, Microsoft Access®, PostgreSQL®, MySQL® and SQLite®, and the like.

The user interface module 312 is configured for receiving one or more inputs for defining various fields in a document 200. The one or more fields in the document 200 include a content field and a context field. The inputs are received from a user through the input mediums. It will be apparent to a person having ordinary skill in the art that any suitable input mediums may be used by the user. In an embodiment, the defining of the one or more fields in the document 200 includes selecting the one or more fields such as the content field or the context field in the document 200. In another embodiment, the defining of the one or more fields in the document 200 includes selecting the one or more fields in the document 200 and thereafter defining one or more areas in the selected one or more fields in the document 200. In yet another embodiment, the defining of one or more fields in the document 200 includes defining text corresponding to the one or more fields in the document 200.

In an embodiment, the user interface module 312 presents a graphical user interface (GUI) on the display 302.

In an embodiment, the document 200 is stored in the database 322. The user interface module 312 retrieves the document 200 from the database 322. The user interface module 312 retrieves the document 200 stored in the database 322 based on the user's selection of the document 200. The user interface module 312 then displays various editing options such as text highlight option, text underlining operation, text bold operation, text italics operation, options for modifying font size, options for modifying text colour, various geometric shapes that facilitates the defining of the one or more fields such as the content field and the context field in the document 200.

The recording module 314 is configured for recording the modifications in the one or more fields of the document 200. The modification includes at least one of comments by readers of the document or edits. In an embodiment, the recording module 314 is used to record actions while the document 200 is being created, developed, or modified. For example, during the course of the document 200 creation, when a new round of modifications is being made, the recording module 314 maintains or stores the modifications including the newly added information and with respect to corresponding location and fields in the document 200. The recording module 314 further updates a version number for the document 200 and stores the version number along with various other information like, a timestamp corresponding to each modification, user details of the user who made the modifications, and so forth.

The code generation module 316 is configured for generating a machine-readable code (MRC) 214 based on the modifications in the one or more fields in the document 200. The MRC 214 can be generated by various techniques known in the art, including but not limited to, 2D barcode VCL components in Delphi or C++ builder applications, J4L components, and Google Chart Tools (Chart API) using HTTP Post or Get methods, various software applications for creating QR codes, Maxicodes, or 2D barcodes, an online application/tool like KAYWA, and the like. For example, an MRC 214 (e.g., a QR code or Dataglyphs) is generated based on the modifications in the one or more fields in the document 200.

The MRC 214 thus generated encodes the one or more modifications in the one or more fields in the document 200. In an embodiment, the MRC 214 may also include information on one or more of the version number, the timestamp corresponding to each modification, user details of the user who made the modifications, the number of times the document 200 has been modified, and so forth. In another embodiment, the MRC 214 is generated such that it encodes the information on the name or type of the field modified. In an embodiment, if the information to be encoded in the MRC is very large, the code generation module 316 generates more than one MRCs. Once the MRC 214 is generated, the code generation module 316 stores the MRC 214 in the database 322.

The code generation module 316 further obtains the MRC 214 from the database 322 and embeds the MRC 214 in the document 200. In an embodiment, the code generation module 316 determines the position of the MRC 214 in the document 200, based on the size of the MRC 214 and empty space available in the document 200. In another embodiment, a user is asked (through the GUI) to define the position of the MRC 214 in the document 200. The code generation module 316 then embeds the MRC 214 at the determined location in the document 200. In an embodiment, if multiple MRCs are generated, the code generation module 316 embeds all the generated MRCs in the document 200. The document 200 with the embedded MRC 214 is then stored in the database 322.

The printing module 318 facilitates printing of the document 200 with the embedded MRC 214. In an embodiment, the printing module 318 corresponds to a print driver. The print driver obtains the document 200 with the embedded MRC 214 from the database 322 and facilitates printing of the document 200 with the MRC 214 depending on the user's command for printing the document 200. The print driver receives a command for printing the document 200 from the user interface module 312. The print driver then initiates the printing of the document 200 having the MRC 214.

The scanning module 320 is configured to scan the MRC 214 to output information on the modifications done in the document 200. The scanning of the MRC 214 comprises decoding of the MRC 214 in order to determine the details of the one or more modifications in the document 200. In order to decode the MRC, the scanning module 320 implements various code decoding techniques such as barcode decoding techniques, QR code decoding techniques, Maxicode decoding techniques, and the like. After the decoding of the MRC 214, each of the one or more modifications is displayed on the display 302. For example, the one or more modifications may include the details of the text edits performed in the document 200, the version number of the document if there has been contextual modifications in the document 200, the timestamp corresponding to each modification in the document 200, the details of the user who made the modifications, the number of times the document 200 has been modified, and so forth. In an embodiment, the scanning module 320 controls various image-capturing units (not shown) such as scanners and digital cameras. In an embodiment, the image capturing units implement various CCD devices and/or CMOS devices to capture the digital images. In an embodiment, the image capturing units implement a linear scanning technique. In another embodiment, the image capturing units implement a two-dimensional scanning technique.

FIG. 4 is a flow diagram illustrating a method for tracking modifications in a document in accordance with at least one embodiment.

At step 402, one or more fields are defined in the document 200. In an embodiment, the input is received for defining the one or more fields in the document 200 by the user interface module 312 through the GUI displayed on the display 302. The one or more areas of fields include a content field or a context field. The one or more fields may be defined by selecting the text, highlighting, one or more text fields, by changing the font size, by changing the text colour, by underlining the text, by text bold operation, by text italics operation, or by any suitable means without departing from the scope of the ongoing description. In an embodiment, the context fields such as the user-related information fields and the title field available in the document 200 are highlighted in bold.

At step 404, the modifications in the one or more fields are recorded. In an embodiment, the recording module 314 records the modifications in one or more fields of the document 200. The modifications in the document 200 include at least one of comments by readers of the document or edits made.

At step 406, a machine-readable code (MRC) 214 is generated based on the modifications. In an embodiment, the MRC 214 is generated for the document 200 by the code generation module 316 based on the modifications in the document 200. The MRC 214 includes the modifications in the content field or the context field of the document 200 in an encoded format.

At step 408, the MRC 214 is embedded in the document 200. The position where the MRC 214 is placed in the document 200 is determined by the code generation module 316. Once the position is decided, the MRC 214 is embedded in the document 200.

At step 410, the document 200 with embedded MRC 214 is printed. In an embodiment, the document 200 can be printed at the computing device 104 (or at any other computing device) in conjunction with suitable printer/MFD. In an embodiment, the printing of the document 200 with embedded MRC 214 is facilitated at the printing module 318. The printing module 318 corresponds to a print driver. The print driver obtains the document 200 with the embedded MRC 214 from the database 322 and facilitates printing of the document 200 with the MRC 214. Thus, the print copies of the document 200 will also contain the MRC 214. The print copies of the document 200 may then be distributed to various user/consumers/readers.

At step 412, the MRC 214 in the printed document 200 is scanned to output information on the modifications. In an embodiment, if the user reading the print copy of the document 200 wants to check the prior modifications in the document 200, he can scan the MRC 214 using any suitable apparatus (e.g., mobile phone with code scanning application like QR code scanning application and the like). The information contained in the MRC 214 may then be displayed on the display of the apparatus. In another embodiment, the scanning of the MRC 214 contained in the document 200 (or the print copy of the document 200) is also facilitated at the computing device 104 by the scanning module 320.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product for tracking modifications in the document, as described above, have various advantages. Some of these advantages may include, but are not limited to, time saving and simplicity in operation. Manual intervention for identifying relevant information individually in each document can be avoided resulting in a speedy, yet easy, process. Additionally, the MRC, such as the QR code, serves as an origin or reference for the one or more modifications done in the document. The decoding of the MRC results in the extracting of the modifications done in the document.

Various embodiments of the method and system for tracking modifications in the document have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules, and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many different systems or applications. Various presently unforeseen or unanticipated alternatives, modifications, variations, or improvements therein may be subsequently made by those skilled in the art, which are also intended to be encompassed by the following claims.

What is claimed is:

1. A method for tracking modifications in a document, the method comprising:
defining one or more fields in the document;
recording the modifications in the one or more fields;
generating a machine-readable code (MRC) based on the modifications; and
embedding the MRC in the document.

2. The method of claim 1, wherein the one or more fields comprises a content field or a context field.

3. The method of claim 1, wherein the defining of the one or more fields comprises at least one of selecting the one or more fields, defining one or more areas of the one or more fields, or defining text corresponding to the one or more fields in the document.

4. The method of claim 3, wherein the defining text comprises performing at least one of selecting, highlighting, underlining, text bold operation, text italics operation, or changing color of the text.

5. The method of claim 1, wherein the modifications comprise at least one of comments by readers of the document or edits.

6. The method of claim 1 further comprising determining a position of the MRC before embedding.

7. The method of claim 1, wherein the MRC corresponds to at least one of a Quick Response (QR) code, a dataglyph, a High Capacity Color Barcode, or a MaxiCode.

8. The method of claim 1 further comprising printing the document with the embedded MRC.

9. The method of claim 1 further comprising scanning the MRC to output information on the modifications.

10. The method of claim 1 further comprising displaying the information on the modifications.

11. The method of claim 1 further comprising updating a version number of the document when modifications are made, and the MRC comprises the version number.

12. The method of claim 1, wherein the MRC comprises information on the number of times the document is modified.

13. A system for tracking modifications in a document, the system comprising:
a user interface module configured for receiving one or more inputs for defining one or more fields;
a recording module configured for recording the modifications in the one or more fields of the document;
a code generation module configured for:
generating a machine-readable code (MRC) based on the modifications in the one or more fields;
determining a position of the MRC in the document; and
embedding the MRC in the document;
a printing module for facilitating printing of the document with the embedded MRC, wherein the MRC, when scanned, enables the output of the information on the modifications.

14. The system of claim 13 further comprising a display configured for displaying the modifications in the one or more fields based on decoding of the MRC.

15. A computer program product for use with a computer, the computer program product comprising a computer-usable data carrier storing a computer-readable program code for tracking modifications in a document, the computer-readable program code comprising:
program instruction means for defining one or more fields in the document;
program instruction means for recording the modifications in the one or more fields;
program instruction means for generating a MRC based on the modifications, and
program instruction means for embedding the MRC in the document.

16. The computer program product of claim 15 further comprising program instruction means for determining a position of the MRC in the document.

17. The computer program product of claim 15 further comprising program instruction means for facilitating printing of the document with the embedded MRC.

18. The computer program product of claim 15 further comprising program instruction means for facilitating scanning of the MRC to output information on the modifications.

19. The computer program product of claim 15 further comprising program instruction means for decoding the MRC.

20. A method for tracking modifications in a document, the method comprising:
defining one or more fields in the document;
recording the modifications in the one or more fields;
generating a machine-readable code (MRC) based on the modifications;
embedding the MRC in the document;
printing the document with the embedded MRC; and
scanning the MRC in printed document to output information on the modifications.
